(19) United States
(12) Patent Application Publication
(10) Pub. No.: US 2025/0072669 A1
(43) Pub. Date: Mar. 6, 2025

(54) SOAP DISPENSER

(71) Applicant: Vanity Group, MARRICKVILLE (AU)

(72) Inventor: Paul Tsalikis, LONDON (GB)

(73) Assignee: Vanity Group, MARRICKVILLE (AU)

(21) Appl. No.: 18/953,759

(22) Filed: Nov. 20, 2024

(30) Foreign Application Priority Data
Aug. 16, 2024 (CN) 202411131867.0

(51) Int. Cl. A47K 5/12

(52) U.S. Cl. CPC A47K 5/1211; A47K 2201/02

(57) ABSTRACT

A soap dispenser includes a structure in which an inner shell and an outer shell are slidably engaged together. An enclosed space is formed after the inner shell and the outer shell are engaged so as to accommodate and hold a refillable bottle or a disposable bag. The inner shell and the outer shell are fixed and locked with each other by a spring and a metal pin, and provided with engaging grooves on the back thereof so as to enhance the connection strength, and allow to be opened only by using a magnetic key. The soap dispenser solves the problems of poor anti-theft and tamper-proof effect, serious plastic waste, contamination caused by repeated filling, difficult maintenance, unattractive appearance, poor user experience, which are of great significance in enhancing the efficiency of the use of cleaning products in public occasions and the user experience.

### CROSS-REFERENCE TO RELATED APPLICATIONS

This application claims priority to Chinese Patent Application No. CN 202411131867.0, filed on Aug. 16, 2024. The content of the aforementioned application, including any intervening amendments thereto, is incorporated herein by reference.

### FIELD

The present application relates to the technical field of soap dispensers, in particular to an anti-theft and tamper-proof soap dispenser for public use with reduced use of plastics.

### BACKGROUND

With development of environmental awareness, there are demands around the world to reduce the use of disposable plastic products, and regulations have been enacted to limit the use of disposable plastic products. One of the most significant impacts on the hotel, aviation and other industries is to replace small bottles of washing and moisturizing daily care products with soap dispensers connected to the wall or tabletop and capable of holding large quantity of liquid.

At present, the soap dispenser commonly used around the world is mainly used to avoid the user from stealing a large bottle of liquid to some extent by fixing the large plastic bottle to the wall. However, it cannot ensure the liquid in the bottle from contamination, because it is generally difficult for the existing soap dispenser to lock the screwable pump head; or a check pump head is adopted and the large plastic bottle is difficult to be filled twice, so that the pump head together with the bottle needs to be replaced when the liquid is used up, resulting in waste of plastics. On the market, there are relatively few soap dispensers that meet requirements of both anti-theft and tamper-proof.

In summary, the existing soap dispensers usually have the problems of poor anti-theft and tamper-proof effect, serious plastic waste, contamination caused by repeated filling, difficult maintenance, unattractive appearance, poor user experience, etc.

### SUMMARY

In view of above, the present application provides a soap dispenser at least mitigating the above problem in the prior art.

In order to achieve the above object, the present application provides the following solutions. A soap dispenser includes a structure in which an inner shell and an outer shell are slidably engaged together. An enclosed space is formed after the inner shell and the outer shell are engaged so as to accommodate and hold a refillable bottle or a disposable bag. The inner shell and the outer shell are fixed and locked with each other by a spring and a metal pin, and provided with engaging grooves on the back thereof so as to enhance the connection strength, and able to be opened only by using a magnetic key. The invention provides the advantages of anti-theft and tamper-resistance with a reduced use of plastics in a publicly used dispenser.

Further, the back of the inner shell has a flat surface and is provided at least one threaded hole. The inner shell is fixed to a wall by adhesive or screw, and a locking mechanism of the inner shell and the outer shell allows the whole soap dispenser to be fixed to the wall.

Further, a tamper-resistant mechanism formed of a pump head, a pump core sleeve and a magnetic key is further included. The pump core sleeve extends from the interior of the outer shell to the outside, and is locked by using a hex wrench at tail of the key and a hex nut at middle section of the pump core sleeve. After the pump core sleeve is screwed to the pump head, relationship between static friction and dynamic friction is controlled to ensure that the pump head cannot be unscrewed from outside for tampering, and only the staff can open the inner shell and the outer shell and use the key to disassemble the pump head.

Further, two liquid storing solutions are provided, one of which is a refillable bottle, and the other of which is a disposable bag.

Further, liquid is pumped from the refillable bottle by cooperation of the pump core sleeve and the pump head, a sealing cover is provided for the bottle to prevent liquid volatilization and contamination.

Further, the disposable bag needs to be used with a guard plate. The bag is fixed by a structure formed of engaging slot and snap of the guard plate and the inner shell, and is pierced by the pump core sleeve to realize use of liquid.

Further, the bottle can be cleaned, disinfected or replaced after repeated filling for a determined number of times, and the bag is disposable. The pump head and the pump core sleeve are in a detachable structure, and also can be cleaned, disinfected or replaced.

Further, a welded structural member is provided inside the outer shell, and a locking mechanism is formed by the welded structural member, the spring and the metal pin. The magnetic key is allowed to be used to compress the spring and suck the pin so as to achieve rapid unlocking and facilitate replacement of contents, and the outer shell and the guard plate are provided with transparent or semitransparent observation widows for easily monitoring residual level of liquid.

Further, all removable parts are designed as being easily cleaned and replaced, and the outer shell and the inner shell are made of corrosion-resistant or easy-to-clean materials.

Compared with the prior art, the present application has the following advantages.
1. Significant Enhancement of Anti-theft Performance: by the slidable fit between the inner shell and the outer shell and the fixing and locking mechanism of the spring and the metal locking pin in conjunction with the design of the engaging groove at the back, the anti-theft performance of the soap dispenser can be greatly enhanced, and it is possible to ensure that unauthorized personnel cannot easily open and steal the liquid in the container.
2. Effective Tamper-proof: the unique synergistic locking design of the pumping assembly, the outer shell, the inner shell and the magnetic key makes it impossible to open the pump head to tamper with it from outside, and only staff members can disassemble the pump head by using the magnetic key, thus ensuring the safety and integrity of the liquid.
3. Reduction of Plastic Waste: there are provided two solutions of refillable soap bottle and single-use soap bag. The reusable soap bottle reduces plastic consumption, whereas the soap bag, although disposable, uses far less plastics than a traditional disposable bottle and does not need to be replaced together with the pump head, further reducing plastic waste.
4. Reduction of Risk of Contamination Caused by Repeated Filling: the soap bottle can be refilled a fixed number of times, and then cleaned, disinfected or replaced, whereas the soap bag is for single-time use, avoiding the possible contamination caused by repeated filling. The pump head and the pump core sleeve are also designed to be removable for cleaning, further ensuring hygiene and safety.
5. Convenience of Maintenance and Content Replacement: the inner shell and the outer shell can be unlocked easily and quickly by the magnetic key, and the design of the observation windows on the outer shell and guard plate enables staff to easily monitor the liquid residual level and replace it timely, which greatly simplifies the maintenance process.
6. Enhancement of User Experience: the innovative connection method eliminates the traditional external limiting mechanism, simplifies the appearance, reduces the user's defensiveness, and enhances the overall user experience. Furthermore, the solid installation design and convenient operation also enhance user satisfaction.

In summary, through a number of technological innovations and design optimization, significant improvements in terms of ensuring safety, reducing waste, lowering contamination, and facilitating maintenance have been achieved, which are of great significance in enhancing the efficiency of the use of cleaning products in public occasions and the user experience.

### BRIEF DESCRIPTION OF THE DRAWINGS

In order to more clearly illustrate technical solutions in the embodiments of the present disclosure or in the prior art, the accompanying drawings to be used in the description of the embodiments or the prior art will be briefly described below. Obviously, the accompanying drawings in the following description are merely exemplary, and other drawings showing other embodiments may be obtained for those skilled in the art on the basis of these accompanying drawings without creative efforts.

The structures, proportions, sizes or the like shown in this specification are only in terms of the contents disclosed in the specification for the understanding and reading of those skilled in the art, and are not intended to limit the implementation of the present disclosure, and therefore do not have any technical substantive significance. Any modification of the structure, any change of the proportion relationship, or any adjustment of the size shall still fall within the scope of the technical contents disclosed in the present disclosure, provided that it does not affect the effect or object achieved in the present disclosure.

FIG. 1 is an exploded perspective view of a soap dispenser according to some embodiments of the present application;

FIG. 2 is a first perspective view of an inner shell of a soap dispenser provided according to some embodiments of the present application;

FIG. 3 is a second perspective view of the inner shelthe soap dispenser for public use with reduced use of plastics provided according to some embodiments of the present application;

FIG. 4 is a perspective view of an outer shell of the soap dispenser according to some embodiments of the present application;

FIG. 5 is a perspective view of a pump core sleeve of the soap dispenser according to some embodiments of the present application;

FIG. 6 is a perspective view of a locking mechanism of the soap dispenser according to some embodiments of the present application;

FIG. 7 is an exploded perspective view of a magnetic key of the soap dispenser according to some embodiments of the present application;

FIG. 8 is a top view showing a locking mechanism opened by the magnetic key for the soap dispenser according to some embodiments of the present application;

FIG. 9 is a perspective view of a guard plate soap dispenser according to some embodiments of the present application;

FIG. 10 is a perspective view showing a soap bottle installed inside the soap dispenser according to some embodiments of the present application;

FIG. 11 is a sectional view showing a soap bottle installed inside the soap dispenser according to some embodiments of the present application; and

FIG. 12 is a sectional view showing a soap bag installed inside the soap dispenser according to some embodiments of the present application.

Reference numerals in the Drawings:

| | | |
|---|---|---|
| 1. inner shell; | 11. limiting projection; | 12. tray; |
| 13. bottle chamber; | 14. first reserved recess; | 15. locking pin hole; |
| 16. threaded hole; | 17. first engaging slot; | 18. engaging plate; |
| 19. outer engaging member; | 2. outer shell; | 21. hollow part; |
| 22. inner engaging member; | 23. clasp outer bracket; | 24. reserved hole; |
| 3. pump core sleeve; | 31. nut; | 32. first stopping ring; |
| 33. threaded groove; | 34. sharp part; | 4. pump head; |
| 5. locking mechanism; | 51. frame body; | 52. limiting column; |
| 53. second stopping ring; | 54. locking pin; | 55. spring; |
| 56. clasp inner bracket; | 6. magnetic key; | 61. shank part; |
| 62. second reserved recess; | 63. hex wrench; | 64. magnet; |
| 7. guard plate; | 71. engaging projection; | 72. bag chamber; |
| 73. guard plate snap; | 74. second engaging slot; | 8. soap bottle; |
| 9. soap bag. | | |

### DETAILED DESCRIPTION OF THE EMBODIMENTS

Hereinafter, the implementation of the present disclosure will be described by specific embodiments. Those skilled in the art can easily understand other advantages and functions of the present disclosure on the basis of disclosure of this specification. It is obvious that the described embodiments are a part of the embodiments of the present disclosure and not all of the embodiments. Based on the embodiments of the present disclosure, all other embodiments obtained by those skilled in the art without creative efforts are within the scope of protection of the present disclosure.

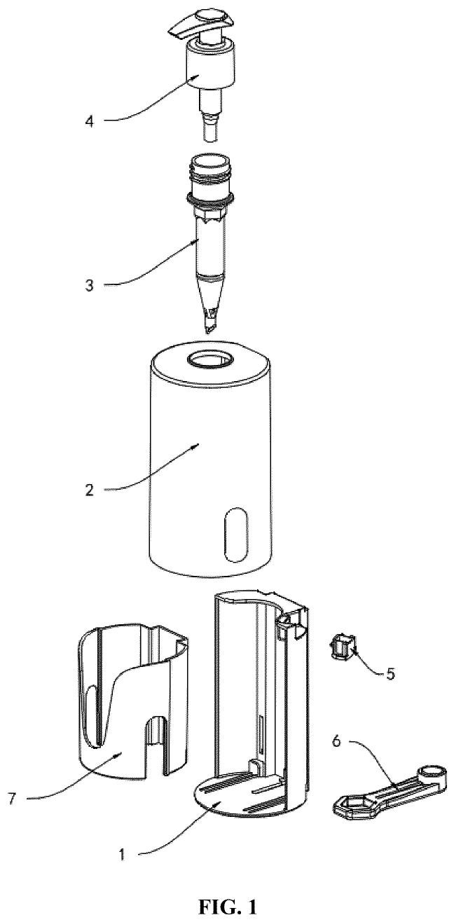

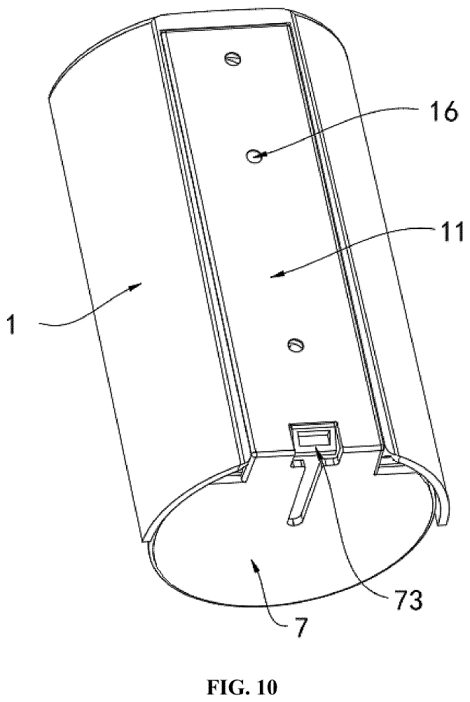

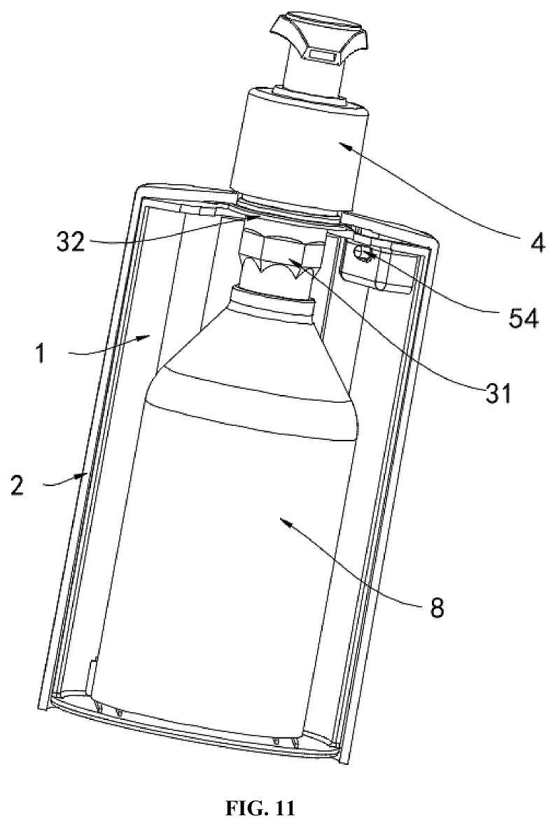

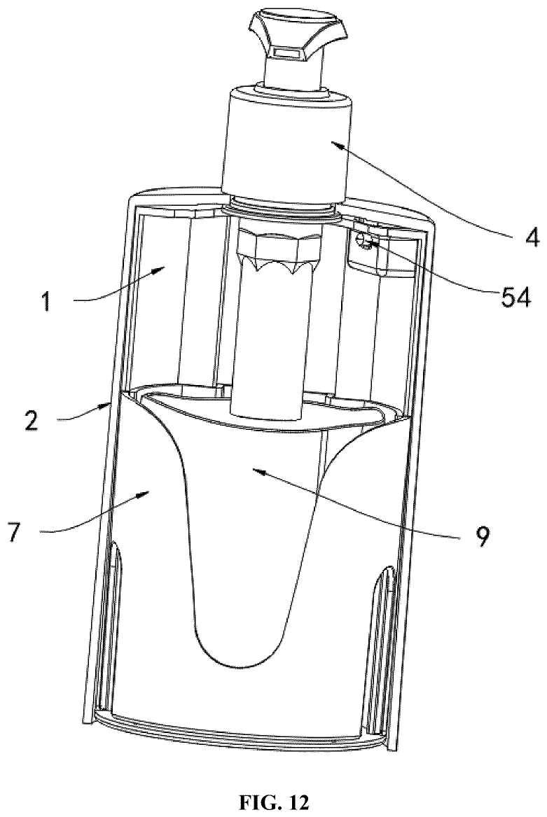

As shown in FIGS. 1 to 12, an anti-theft and tamper-proof soap dispenser for public use with reduced use of plastics according to an embodiment in a first aspect of the present application includes an inner shell 1 and an outer shell 2. After the inner shell 1 and the outer shell 2 are assembled, an enclosed space is formed for accommodating a soap bottle 8 or a soap bag 9. When the soap bag 9 is placed in the enclosed space, a guard plate 7 needs to be used together with the soap bag to support the flexible soap bag 9. A pumping assembly is mounted on the top of the outer shell 2 and capable of pumping soap liquid. The inner shell 1 and the outer shell 2 are fixed and locked with each other by a locking mechanism 5. The locking mechanism 5 can be opened only by using a magnetic key 6.

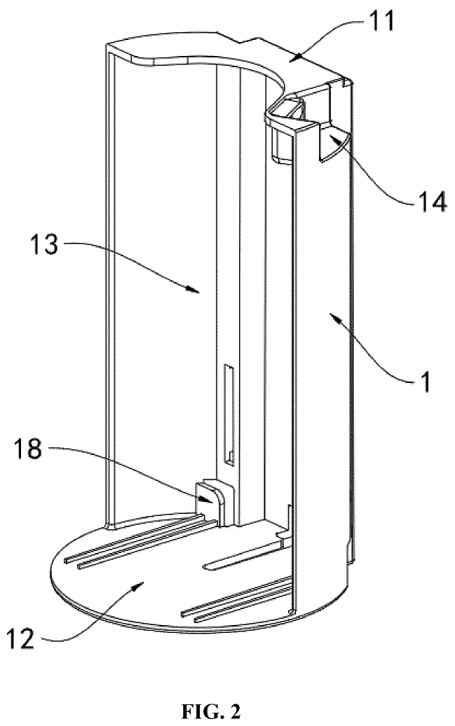

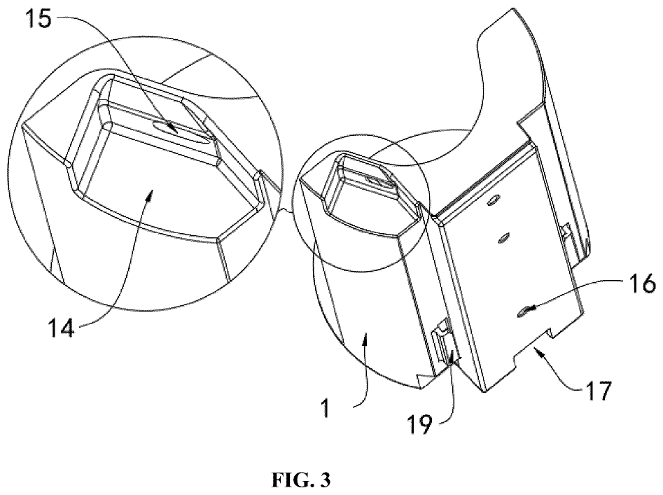

As shown in FIGS. 2 to 3, the inner shell 1 is fixed to the wall. The inner shell 1 is provided at its back with a limiting projection 11, and is integrally connected at its bottom with a tray 12. A bottle chamber 13 is provided inside the inner shell 1 to accommodate the soap bottle 8 or the guard plate 7, and a first reserved recess 14 is provided at the top of the inner shell 1 to receive the locking mechanism 5. A locking pin hole 15 is opened at a side of the first reserved recess 14. Several threaded holes 16 are opened in the limiting projection 11, so that the inner shell 1 can be installed on the wall by screws and the threaded holes 16. A first engaging slot 17 is provided at the bottom of the limiting projection 11. engaging plates 18 are symmetrically arranged at junction between the limiting projection 11 and the tray 12. L-shaped outer engaging members 19 are connected to the back of the inner shell 1 at opposite sides of the limiting projection 11.

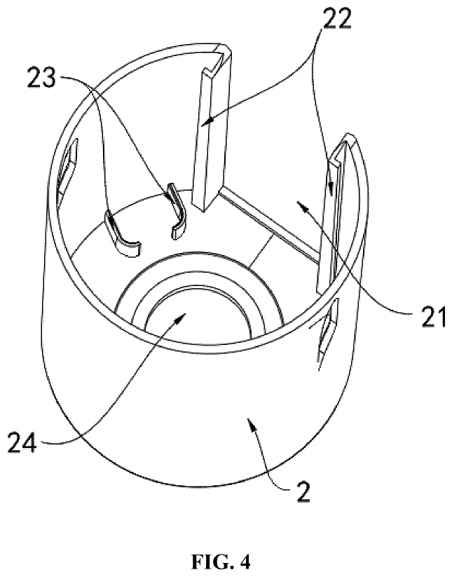

As shown in FIG. 4, a hollow part 21 is provided on the back of the outer shell 2, and L-shaped inner engaging members 22 are provided on the back of the outer shell 2 at opposite sides of the hollow part 21. A clasp outer bracket 23 is provided on the inner surface of the top of the outer shell 2, and a reserved hole 24 is opened on the top of the outer shell 2.

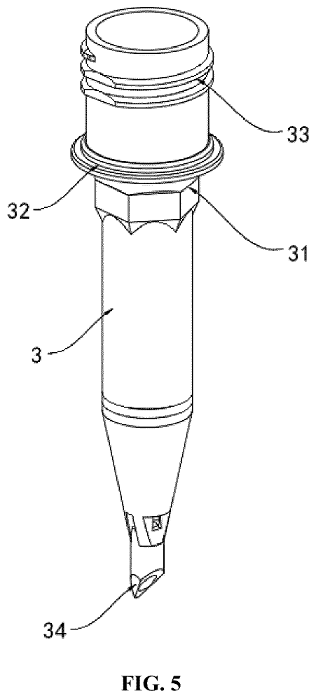

As shown in FIG. 5, a nut 31 is fixedly connected to the outer part of a pump core sleeve 3, and a first stopping ring 32 is fixedly connected to the outer part of the pump core sleeve 3 above the nut 31. A threaded groove 33 is provided on the outer side of the top of the pump core sleeve 3 and configured to be threadedly connected with a pump head 4. A sharp part 34 is provided at the bottom of the pump core sleeve 3 and configured to pierce the soap bag 9.

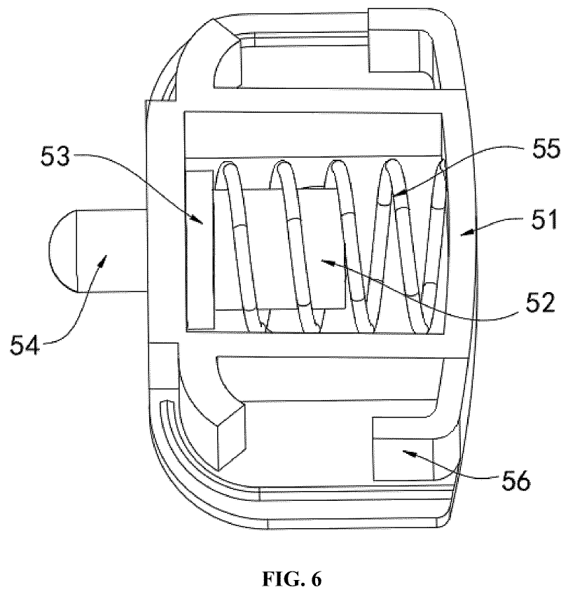

As shown in FIG. 6, the locking mechanism 5 includes a frame body 51, a limiting column 52 slidably connected inside the frame body 51, a second stopping ring 53 connected to the end of the limiting column 52, a locking pin 54 connected to the end of the second stopping ring 53, a spring 55 provided inside the frame body 51 and abutting between the frame body 51 and the second stopping ring 53, and clasp inner brackets 56 integrally connected at opposite sides of the frame body 51.

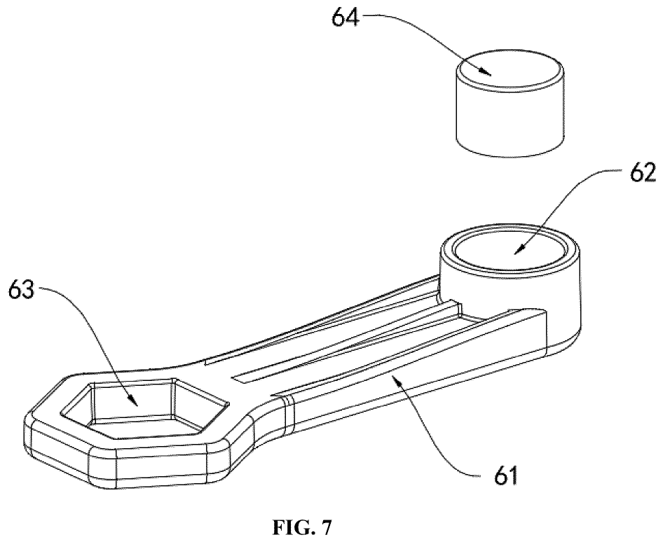

As shown in FIG. 7, the magnetic key 6 includes a shank part 61, a second reserved recess 62 provided at one end of the shank part 61, a hex wrench 63 connected to the other end of the shank part and matched with the nut 31, and a magnet 64 fixedly arranged in the second reserved recess 62.

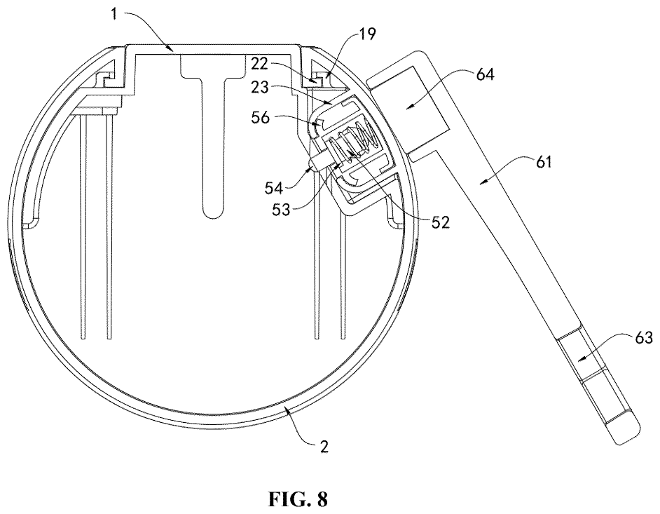

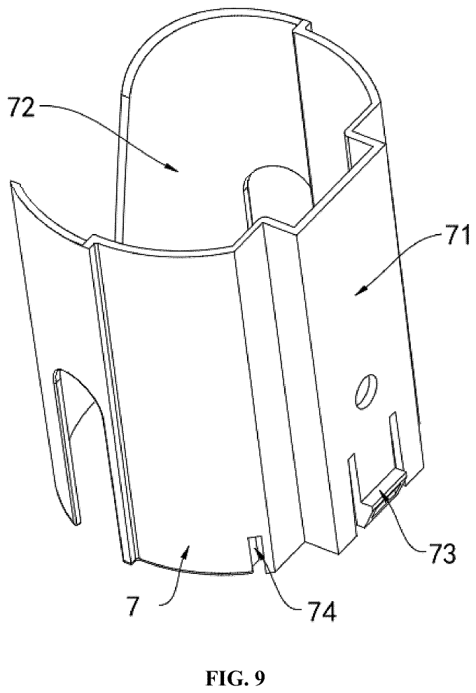

As shown in FIGS. 8 to 9, an engaging projection 71 is provided on the back of the guard plate 7 and matched with the limiting projection 11, and a bag chamber 72 is provided inside the guard plate 7 and can accommodate the soap bag 9. A guard plate snap 73 is connected to the bottom of the engaging projection 71. The guard plate snap 73 may be deformed when being pressed, and otherwise may return back. Second engaging slots 74 are provided on both sides of the bottom of the guard plate 7.

The solutions for solving the problems of poor anti-theft and tamper-proof effect, serious plastic waste, contamination caused by repeated filling, difficult maintenance, unattractive appearance, poor user experience are provided in the following embodiments.

First, in the anti-theft solutions, the inner shell 1 and the outer shell 2 are engaged in a slidable fit matter, and a space is formed after the inner shell 1 and the outer shell 2 are engaged, so as to accommodate the soap bottle 8 or the soap bag 9 for containing daily chemical liquid; the inner shell 1 and the outer shell 2 are fixed and locked relative to each other by using the spring 55 and the metal locking pin 54; and the connection between the inner shell and the outer shell are further strengthened by the corresponding engaging slots located on the backs thereof. Therefore, the general uses cannot open the inner shell 1 and the outer shell 2 by themselves to steal the container containing liquid. A staff can use the magnetic key 6 to open the inner shell and the outer shell. The limiting projection 11 on the back of the inner shell 1 has a flat surface on which multiple threaded holes 16 are arranged, so that glue or screws may be chosen to fix the inner shell 1 to the wall. Since the inner shell and the outer shell may be locked with each other, the product may be wholly fixed to the wall.

Second, in the solution for solving the problem of poor tamper-proof effect, the inner shell 1 and the outer shell 2 may be interlocked with each other on the wall to discourage pilferage, and the reserved hole 24 is provided on the upper end of the outer shell 2 to be engaged with the pump core sleeve 3 and the pump head 4. By means of the outer shell 2, the pump core sleeve 3, the pump head 4, the magnetic key 6 and the like, the pump core sleeve 3 is inserted from the interior of the outer shell 2 via the reserved hole 24 upwardly to the outside such that the threaded groove 33 on the upper section of the pump core sleeve 3 is exposed outside of the outer shell 2, and then is locked in the outer shell 2 by using a hex wrench 63 at the tail of the magnetic key 6 and a hex nut 31 at the middle section of the pump core sleeve 3; then, the fixed pump core sleeve 3 is screwed to the pump head 4, with the screw thread of the pump head 4 being connected with the threaded groove 33 of the pump core sleeve 3, until the lower surface of the pump head 4 becomes contact with the upper surface of the outer shell 2 and the upper surface of the first stopping ring 32 on the middle section of the pump core sleeve 3 becomes contact with the upper inner surface of the outer shell 2; by controlling friction force, the static friction between the screw thread of the pump head 4 and the threaded groove 33 after screw connection is larger than the sum of the dynamic friction between the pump head 4 and the outer shell 2 generated as the pump head 4 is screwed externally and the dynamic friction between the pump core sleeve 3 and the outer shell 2, so that the pump head 4 cannot be rotated to open from outside to tamper liquid. After the inner shell 1 and the outer shell 2 are opened, the staff may use the hex wrench 63 of the magnetic key 6 to detach the pump head 4 from the pump core sleeve 3.

Third, in the solution for solving the problem of serious plastic waste, after the inner shell 1 and the outer shell 2 are connected, a space is formed therein to accommodate the soap bottle 8 or the soap bag 9 for storing liquid. The embodiment provides two liquid storing solutions of the soap bottle 8 and the soap bag 9. In the solution of the soap bottle 8, liquid may be pumped from the interior of the bottle by cooperation of the pump core sleeve 3 and the pump head 4 and may be filled repeatedly, reducing use of disposable plastics and reducing plastic waste. Furthermore, when the soap bag 9 is used, the guard plate 7 needs to be also used. The guard plate 7 is provided with a guard plate snap 73 and second engaging slots 74 which can be engaged with the first engaging slot 17 and the engaging plates 18 at the bottom of the inner shell 1 respectively to form a semi-enclosed space so that the soap bag 9 may be placed through the notch. The bag can be fixed by the guard plate 7 and the inner shell 2. The fixed soap bag 9 may be pierced by the sharp part 34 at the bottom of the pump core sleeve 3 when the inner shell 1 is engaged with the outer shell 2, thereby achieving the use of the soap bag 9 for containing liquid. The soap bag 9 is disposable, but significantly reduces the use of plastics compared with the disposable bottle. The soap bag 9 does not need to be replaced together with the pump head.

Fourth, in solution for solving the problem of contamination caused by repeated filling, as to the two liquid storing solutions of the soap bottle 8 and the soap bag 9, the soap bottle 8 may be repeatedly filled with liquid a predetermined number of times and then be cleaned, sterilized or replaced, whereas the soap bag 9 is for a single-time use and thus has no problem of contamination caused by repeated filling. The pump head 4 and the pump core sleeve 3 constitute a detachable structure, and may be used a predetermined number of times and then be cleaned, sterilized or replaced.

Fifth, in the solution for solving the problem of difficult maintenance, the spring 55 and the metal locking pin 54 are used between the inner shell 1 and the outer shell 2 to fix and lock the inner shell 1 and the outer shell 2. There is a welded structural member at the upper inner end of the outer shell 2, which can form a space inside the outer shell 2 for accommodating the metal locking pin 54 and the corresponding spring 55. The locking pin 54 may pass through a reserved hole of the welded member, so that the head of the locking pin 54 extends to the outside through the reserved hole and is engaged with the locking pin hole 15 at the upper end of the inner shell 1, achieving the function of engaging. The staff can use the magnet 64 on the front section of the magnetic key 6 to draw the locking pin 54 and compress the spring 55, so that the locking pin 54 is separated from the locking pin hole 15, thereby completing the action of unlocking. Unlocking is convenient and simple, and the contents can be quickly replaced after unlocking. The outer shell 2 and the guard plate 7 may be each provided with an observation window through which the staff can easily observe the liquid residual amount of the contents. Thus, the replacement may be carried out at appropriate time.

Sixth, in the solution for solving the problem of unattractive appearance and poor user experience, through innovative connection method, the external limiting mechanism used to press or lock the pump in the traditional soap dispenser may be eliminated, avoiding the appearance of cumbersome; and due to elimination of the external limiting mechanism, it can reduce the transmission of defensive information to the user and improve the user experience.

Although the present disclosure has been described in detail above by a general description and specific embodiments, some modifications or improvements may be made on the basis of the present disclosure, which will be obvious to those skilled in the art. Therefore, these modifications or improvements made without departing from the spirit of the present disclosure are within the scope of protection of the present disclosure.

The terms such as “upper”, “lower”, “left”, “right”, “middle” used in this specification are only for the purpose of clarity and are not intended to limit the scope of the present disclosure, and changes or adjustments in the relative relationships thereof shall be considered to be within the scope of the present disclosure in the absence of substantial changes in the technical content.

What is claimed is:

1. A soap dispenser, comprising a structure in which an inner shell and an outer shell are slidably engaged together, wherein an enclosed space is formed after the inner shell and the outer shell are engaged so as to accommodate and hold a refillable bottle or a disposable bag, and wherein the inner shell and the outer shell are fixed and locked with each other by a spring and a metal pin, provided with engaging grooves on a back thereof so as to enhance connection strength, and able to be opened only by using a magnetic key.

2. The soap dispenser according to claim 1, wherein a back of the inner shell has a flat surface and is provided with at least one threaded hole, the inner shell is fixed to a wall by adhesive or screw, a locking mechanism of the inner shell and the outer shell allows the whole soap dispenser to be fixed to the wall.

3. The soap dispenser according to claim 1, further comprising a tamper-proof mechanism formed of a pump head, a pump core sleeve and a magnetic key, wherein the pump core sleeve extends from an interior of the outer shell to outside, and is locked by using a hex wrench at tail of the key and a hex nut at middle section of the pump core sleeve, and wherein after the pump core sleeve is screwed to the pump head, relationship between static friction and dynamic friction is controlled to ensure that the pump head is unable to be unscrewed from outside for tampering, the inner shell and the outer shell are only capable of being opened by a staff and the pump head is disassemble only by using the key.

4. The soap dispenser according to claim 1, wherein two liquid storing solutions are provided, one of which is a refillable bottle, and the other of which is a disposable bag.

5. The soap dispenser according to claim 4, wherein liquid is pumped from the refillable bottle by cooperation of the pump core sleeve and the pump head, a sealing cover is provided for the bottle to prevent liquid volatilization and contamination.

6. The soap dispenser according to claim 4, wherein the disposable bag needs to be used with a guard plate, and the bag is fixed by a structure of engaging slot and snap of the guard plate and the inner shell, and is pierced by the pump core sleeve to realize use of liquid.

7. The soap dispenser according to claim 6, wherein the bottle is capable of being cleaned, disinfected or replaced after repeated filling for a determined number of times, the bag is disposable, the pump head and the pump core sleeve are in a detachable structure, and also capable of being cleaned, disinfected or replaced.

8. The soap dispenser according to claim 1, wherein a welded structural member is provided inside the outer shell, a locking mechanism is formed by the welded structural member, the spring and the metal pin, the magnetic key is allowed to be used to compress the spring and suck the pin so as to achieve rapid unlocking and facilitate replacement of contents, the outer shell and the guard plate are provided with transparent or semitransparent observation widows for easily monitoring residual level of liquid.

9. The soap dispenser according to claim 1, wherein all removable parts are designed as being easily cleaned and replaced, and the outer shell and the inner shell are made of corrosion-resistant or easy-to-clean materials.
